(19) United States
(12) Patent Application Publication
(10) Pub. No.: US 2009/0168252 A1
(43) Pub. Date: Jul. 2, 2009

(54) HEAD STACK ASSEMBLY AND DISK DRIVE APPARATUS PROVIDED WITH THE SAME

(75) Inventors: Kazuo ITO, Mitaka-shi (JP); Shinji FUJIMOTO, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/244,632

(22) Filed: Oct. 2, 2008

(30) Foreign Application Priority Data
Dec. 27, 2007 (JP) 2007-338310

(51) Int. Cl. G11B 5/55

(52) U.S. Cl. 360/264

(57) ABSTRACT

According to one embodiment, a head stack assembly includes a bearing portion configured to be mounted with a maximum number of arms and a plurality of spacers, a smaller number of arms than the maximum number attached to the bearing portion and extending in the same direction from the bearing portion, a spacer attached to the bearing portion and stacked in layers between the adjacent arms, suspensions and heads attached to the arms, individually, a support frame which supports a coil, and a dummy spacer attached to the bearing portion so as to overlap the arms. The dummy spacer integrally includes a spacer body formed with a thickness equal to the sum of those of the smaller number of arms than the maximum and the spacer arranged between the smaller number of arms, and a balancing portion extending along the extension of the arms from the spacer body.

### CROSS-REFERENCE TO RELATED APPLICATIONS

This application is based upon and claims the benefit of priority from Japanese Patent Application No. 2007-338310, filed Dec. 27, 2007, the entire contents of which are incorporated herein by reference.

### BACKGROUND

1. Field

One embodiment of the present invention relates to a head stack assembly used in a disk drive apparatus provided with a disk recording medium and a disk drive apparatus provided with the same.

2. Description of the Related Art

In recent years, disk devices, such as magnetic disk devices, optical disc devices, etc., have been widely used as external recording devices of computers or image recording apparatuses.

A magnetic disk device, e.g., a hard disk drive (HDD), generally includes a magnetic disk or disks, spindle motor, magnetic head(s), head stack assembly, voice coil motor, board unit, etc. The spindle motor rotates the magnetic disk. The magnetic head reads and writes data from and to the disk. The head stack assembly supports the head. The voice coil motor drives the head stack assembly. These elements are contained in a housing of a substantially sealed structure.

The head stack assembly includes a bearing portion, head gimbal assemblies (HGAs) extending from the bearing portion, and a support frame that extends oppositely from the HGAs and supports a coil of the voice coil motor. Each HGA includes an arm extending from the bearing portion, a suspension extending from the arm, and a head attached to the suspension by a gimbal portion. A plurality of arms are fixed in layers to the bearing portion with spacers between them.

Two HGAs are provided for its obverse and reverse surfaces of each magnetic disk. In a disk drive apparatus that uses two magnetic disks, for example, a head stack assembly includes four HGAs that are stacked in layers on a bearing portion with spacers between them.

Recently, there have been provided low-priced magnetic disk devices composed of, for example, a housing, drive mechanism, head stack assembly, etc., which are shared by one as the aforesaid high-end model for two magnetic disks, such that the magnetic disks and HGAs are reduced in number. The manufacturing cost of these magnetic disk devices are reduced by the use of common components.

For example, the number of HGAs is reduced to two in the case where a head stack assembly designed for two magnetic disks is used as a one-disk version If the number of HGAs is thus reduced, the weight balance of the entire head stack assembly is broken, so that the center of gravity of the assembly is inevitably deviated from the bearing portion. In order to improve the positioning accuracy of the head, it is important to align the center of gravity of the head stack assembly with the center of rotation of the bearing portion. Thereupon, the weight balance of the head stack assembly is adjusted by attaching, together with the two HGAs, a spacer and two dummy arms that resemble arms in shape and structure, in place of the reduced HGAs.

Further, an arrangement for adjusting the weight balance of another type of head stack assembly is proposed in Jpn. Pat. Appln. KOKAI Publication No. 2002-170345, for example. According to this arrangement, the configuration of the bearing portion is modified so that it can be fitted with a balance weight, which is to be alternatively attached to the bearing portion if the number of HGAs is reduced.

In the case of a configuration such that the dummy arms and the spacer are stacked in layers, as described in the above patent document, however, it is difficult to reduce the manufacturing cost of the entire head stack assembly, since the dummy arms entail relatively high cost. Since dummy arms and spacers that compensate for the reduction of the HGAs must be attached to the bearing portion at the time of assembly, moreover, the number of processes for assembly cannot be reduced. An assembly tolerance is added for each set of dummy arms, so that the position of the center of gravity is liable to fluctuations.

If the bearing portion is configured to be fitted with the balance weight, as described in the foregoing patent document, the design of the bearing portion itself should be modified, and the bearing portion is increased in size to accommodate a weight mounting portion.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary exploded perspective view showing an HDD according to an embodiment of the invention with its top cover off;

FIG. 2 is an exemplary perspective view showing a head stack assembly of the HDD;

FIG. 3 is an exemplary exploded perspective view of the head stack assembly;

FIG. 4A is an exemplary plan view of the head stack assembly;

FIG. 4B is an exemplary sectional view of the head stack assembly taken along line IVB-IVB of FIG. 4A; and

FIG. 5 is an exemplary sectional view showing a bearing portion of the head stack assembly.

### DETAILED DESCRIPTION

Various embodiments according to the invention will be described hereinafter with reference to the accompanying drawings. In general, according to one embodiment of the invention, there is provided a head stack assembly comprising: a bearing portion configured to be mounted with a maximum number of arms and a plurality of spacers situated between the adjacent arms in a stacked state; a smaller number of arms than the maximum number attached to the bearing portion and extending in the same direction from the bearing portion; a spacer attached to the bearing portion and stacked in layers between the adjacent arms; suspensions and heads attached to the arms, individually; a support frame which extends from the bearing portion oppositely from the arms and supports a coil; and a dummy spacer integrally including a spacer body, which is attached to the bearing portion so as to overlap the arms and formed with a thickness equal to the sum of those of the smaller number of arms than the maximum and the spacer arranged between the smaller number of arms, and a balancing portion extending along the extension of the arms from the spacer body.

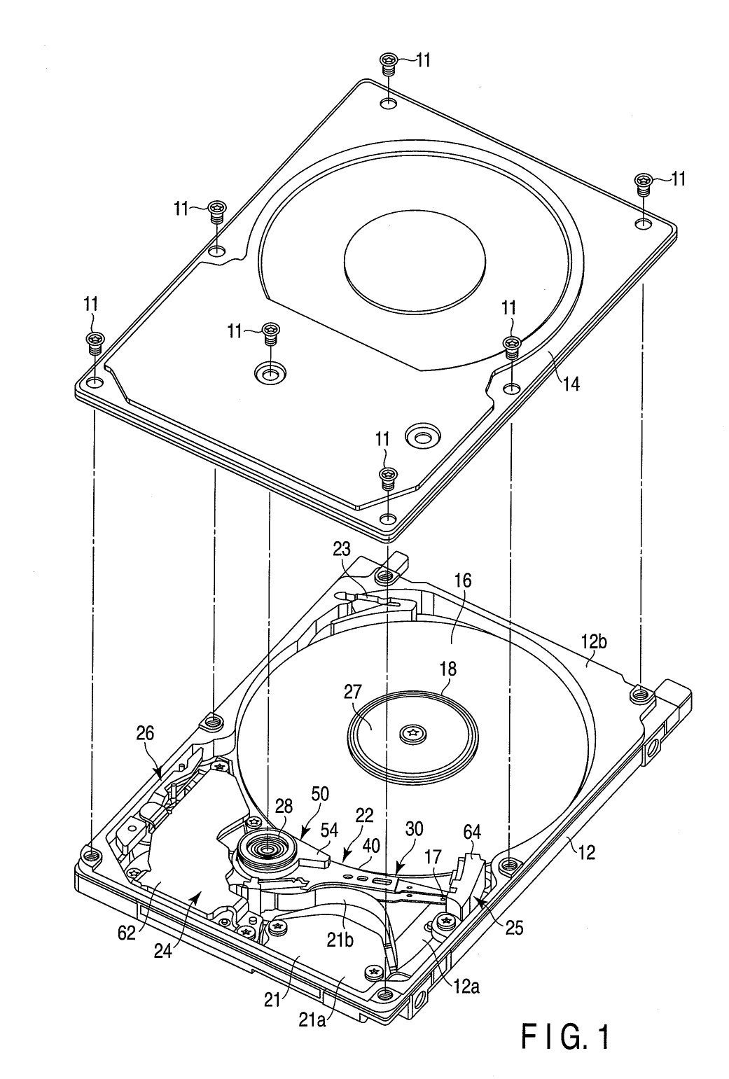

An HDD according to an embodiment of this invention will now be described in detail with reference to the accompanying drawings. FIG. 1 shows the internal structure of the HDD with its top cover off. As shown in FIG. 1, the HDD is provided with a housing 10. The housing 10 includes a base 12 in the form of an open-topped rectangular box and a top cover 14, which is fastened to the base by screws 11 so as to close the top opening of the base. The base 12 includes a rectangular bottom wall 12a and a sidewall 12b set up along the peripheral edge of the bottom wall.

The housing 10 contains one magnetic disk 16 for use as a recording medium and a spindle motor 18 as a drive section that supports and rotates the magnetic disk. The spindle motor 18 is located on the bottom wall 12a. The housing 10 has a size large enough to accommodate a plurality of, e.g., two, magnetic disks, and the spindle motor 18 is configured to support and drive two magnetic disks.

The housing 10 further contains magnetic heads 17, head stack assembly (HSA) 22, voice coil motor (VCM) 24, ramp load mechanism 25, latch mechanism 26, and board unit 21. The magnetic heads 17 record and reproduce information to and from the magnetic disk 16. The HSA 22 supports the heads 17 for movement with respect to the disk 16. The VCM 24 rocks and positions the HSA 22. The ramp load mechanism 25 holds the magnetic heads in a retracted position at a distance from the magnetic disk when the heads are moved to the outermost periphery of the disk. The latch mechanism 26 holds the HSA in its retracted position when the HDD is jolted. The board unit 21 includes a preamplifier and the like. A printed circuit board (not shown) is screwed to the outer surface of the bottom wall 12a of the base 12. The circuit board controls the operations of the spindle motor 18, VCM 24, and magnetic heads through the board unit 21. A circulation filter 23 is disposed on the sidewall of the base 12 and situated outside the magnetic disk 16. The filter 23 captures dust that is produced in the housing when any moving part is operated.

The magnetic disk 16 is formed with a diameter of, for example, 65 mm (2.5 inches) and has magnetic recording layers on its upper and lower surfaces, individually. The disk 16 is coaxially fitted on a hub (not shown) of the spindle motor 18 and clamped and fixed on the hub by a clamp spring 27. Thus, the disk 16 is supported parallel to the bottom wall 12a of the base 12. The disk 16 is rotated at a predetermined speed of, for example, 5,400 or 7,200 rpm by the spindle motor 18.

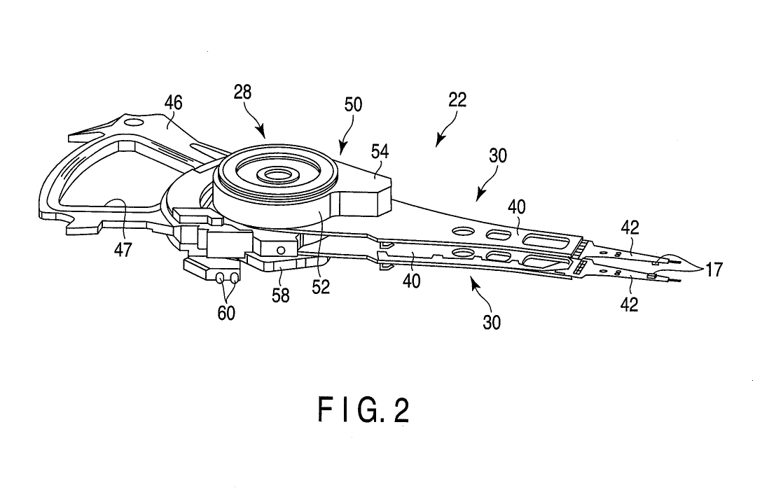

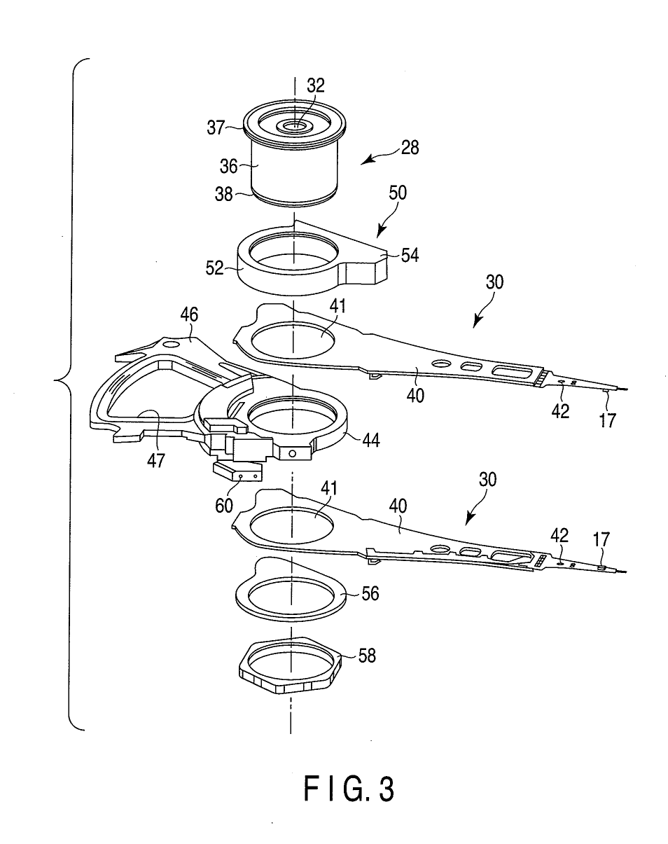

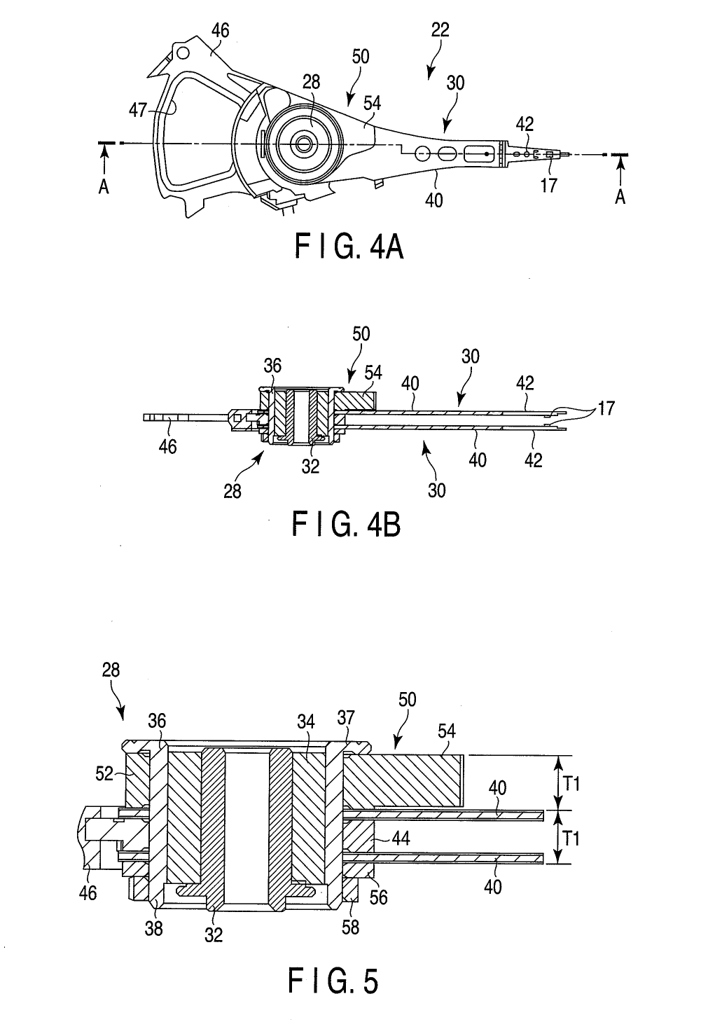

FIG. 2 is a perspective view showing the HSA 22, and FIG. 3 is an exploded perspective view of the HSA. FIGS. 4A and 4B are a plan view and a sectional view, respectively, showing the HSA. FIG. 5 is a partial enlarged sectional view of the HSA. As shown in FIGS. 1 to 5, the HSA 22 is provided with a rotatable bearing portion 28, two head gimbal assemblies (HGAs) 30 extending from the bearing portion, a spacer ring 44 laminated between the HGAs, and a dummy spacer 50 (mentioned later).

The bearing portion 28 is situated apart from the center of rotation of the magnetic disk 16 along the length of the base 12 and near the outer peripheral edge of the disk. The bearing portion 28 includes a pivot 32 set up on the bottom wall 12a of the base 12 and a cylindrical sleeve 36 coaxially supported for rotation on the pivot by a bearing 34. An annular flange 37 is formed on the upper end of the sleeve 36, while a thread portion 38 is formed on the outer periphery of its lower end portion. The sleeve 36 of the bearing portion 28 is formed with such a size, or an axial length in this case, that four HGAs at the most, for example, and spacers between adjacent pairs of HGAs can be mounted in layers.

Since the magnetic disk 16 is set to be one in number in the present embodiment, the bearing portion 28 is provided with two HGAs 30, the number of which is smaller than four, the maximum mountable number, by two. Each HGA includes an arm 40 extending from the bearing portion 28, a suspension 42 extending from the arm, and the magnetic head 17 supported on an extended end of the suspension by a gimbal portion.

The arm 40 is a thin flat plate formed by laminating, for example, stainless steel, aluminum, and stainless steel layers to one another. A circular through hole 41 is formed in one end or proximal end of the arm 40. The suspension 42 is formed of an elongated leaf spring, and its proximal end is fixed to the distal end of the arm 40 by spot welding or adhesive bonding and extends from the arm. The suspension 42 and the arm 40 may be formed integrally of the same material.

The magnetic head 17 includes a substantially rectangular slider (not shown) and a magnetoresistive (MR) write/read head formed on the slider and is fixed to the gimbal portion formed on the distal end portion of the suspension 42. Further, the magnetic head 17 includes four electrodes (not shown). A relay flexible printed circuit board (FPC, not shown) is set on the arm 40 and the suspension 42. The magnetic head 17 is electrically connected to a main FPC 21b (mentioned later) through the relay FPC.

The spacer ring 44 is formed of aluminum or the like having a predetermined thickness and a predetermined outside diameter. A plastic support frame 46 is molded integrally with the spacer ring 44 and extends outward from the spacer ring. A voice coil 47 of the VCM 24 is fixed to the support frame 46.

The dummy spacer 50 includes an annular spacer body 52 and a balancing portion 54 extending from the spacer body and is integrally formed of a metal such as stainless steel. The outside diameter of the spacer body 52 is equal to that of the spacer ring 44. More specifically, the outside diameter of that part of the spacer body 52 which contacts the arm 40 is equal to that of that part of the spacer ring 44 which contacts the arm. Further, a thickness T1 of the spacer body 52 is equal to the sum of those of the arms of the smaller number of HGAs than the maximum, that is, the two arms, and the spacer ring arranged between these arms.

The dummy spacer 50, the two HGAs 30, and the spacer ring 44 are fitted on the sleeve 36 of the bearing portion 28 that is passed through the bore of the spacer body 52, the through hole 41 of the arm 40, and the bore of the spacer ring, and are stacked in layers on the flange 37 along the axis of the sleeve. The spacer body 52 of the dummy spacer 50 and the spacer ring 44 are fitted on the sleeve 36 in such a manner that they are sandwiched between the flange 37 and one of the arms 40 and between the two arms 40, respectively. Further, an annular washer 56 is fitted on the lower end portion of the sleeve 36.

The dummy spacer 50, two arms 40, spacer ring 44, and washer 56 that are fitted on the sleeve 36 are sandwiched between the flange 37 and a nut 58, which is threadedly fitted on the thread portion 38 of the sleeve 36, and are fixedly held on the outer periphery of the sleeve.

The two arms 40 are located individually in relatively predetermined positions with respect to the circumference of the sleeve 36 and extend in the same direction from the sleeve. Thus, the two HGAs are rockable integrally with the sleeve 36 and extend parallel to the surfaces of the magnetic disk 16 so as to face each other across a predetermined space. Further, the support frame 46 that is integral with the spacer ring 44 extends from the bearing portion 28 oppositely from the arms 40. Two pin-like terminals 60 protrude from the support frame 46 and are electrically connected to the voice coil 47 through a conducting member (not shown) that is embedded in the frame 46.

As shown in FIGS. 2, 4A, 4B, and 5, the balancing portion 54 of the dummy spacer 50 extends along the extension of the arms 40 from the spacer body 52 and is located within a region that overlaps the arms. The balancing portion 54 is formed to be a little thinner than the spacer body 52 and faces the arm 40 across a gap. The balancing portion 54 is formed to have a shape, size, and weight such as to make up for the weight of a number of HGAs smaller than the maximum mountable number, that is, the two HGAs in this case, and that the center of gravity of the entire HSA 22 is situated on the center of rotation of the bearing portion 28.

When the HSA 22 constructed in this manner is incorporated in the base 12, as seen from FIG. 1, the magnetic disk 16 is situated between the two HGAs 30. While the HDD is operating, the magnetic heads 17 that are attached individually to the arms 40 face the upper and lower surfaces, individually, of the magnetic disk 16 and hold the disk from both sides. The voice coil 47 that is fixed to the support frame 46 is situated between a pair of yokes 62 that are fixed on the base 12. The coil 47, along with these yokes and a magnet (not shown) fixed to one of the yokes, constitutes the VCM 24.

As shown in FIG. 1, the board unit 21 includes a body 21a that is formed of a flexible printed circuit board. The body 21a is fixed to the bottom wall 12a of the base 12. An electronic component, such as a head amplifier, is mounted on the body 21a. The board unit 21 includes the main flexible printed circuit board (main FPC) 21b that extends from the body 21a. An extended end of the main FPC 21b is connected to the vicinity of the bearing portion 28 of the HSA 22 and also electrically connected to the magnetic heads 17 by relay FPCs (not shown) on the arms 40 and the suspensions 42. A connector (not shown) for connection with the printed circuit board is mounted on the bottom surface of the body of the board unit 21

The ramp load mechanism 25 includes a ramp 64 and tabs. The ramp 64 is provided on the bottom wall 12a of the base 12 and located outside the magnetic disk 16. The tabs extend individually from the respective distal ends of the suspensions 42. As the HSA 22 rocks so that each magnetic head 17 is moved to its retracted position outside the magnetic disk 16, each tab engages with a ramp surface formed on the ramp 64 and is then pulled up along the slope of the ramp surface. Thereupon, each magnetic head 17 is unloaded from the magnetic disk 16 and held in the retracted position.

According to the HDD constructed in this manner, the magnetic disk 16 is rotated at high speed during operation. If the voice coil 47 is energized, the HSA 22 rocks around the bearing portion 28, whereupon each magnetic head 17 is moved to and positioned in a region over a desired track of the magnetic disk 16. Thus, the head 17 can perform information processing, that is, write or read information to or from the disk 16.

According to the arrangement described above, the HDD for the single magnetic disk is constructed using the housing 10 that is also shared by a high-end model for two magnetic disks and drive sections. Thus, HDDs as low-end models with small recording capacities can be manufactured at low cost. In the HSA 22, the single dummy spacer 50 is located on the bearing portion 28 in place of the two HGAs and the single spacer ring. In this case, the weight balance of the USA is adjusted by means of the dummy spacer, whereby the center of gravity of the HGA is aligned to the center of rotation of the bearing portion. Since the spacer body 52 of the dummy spacer 50 has a thickness equal to the sum of those of the two arms and the spacer ring, a plurality of HGAs can be located in layers on the bearing portion 28 by attaching the single dummy spacer to the sleeve of the bearing portion without further providing any other component.

Thus, the single dummy spacer 50 should only be provided in place of the conventionally required three components including the two dummy arms and the one spacer ring. Accordingly, the number of essential components can be reduced, so that the number of man-hours for assembly, as well as the manufacturing cost, can be reduced. By reducing the number of components, moreover, fluctuations of the position of the center of gravity attributable to dislocation of the components can be lessened, so that the product quality can be improved. By reducing the number of components, at the same time, tolerances between the components that are laminated to one another on the bearing portion can be reduced, so that the height variation of the magnetic heads can be reduced. In the conventional case where the three components including the two dummy arms and the spacer ring are laminated to one another on the bearing portion, the total tolerance of the three components is ±0.015 mm if the tolerance of each component is ±0.005 mm, for example. In the case where the dummy spacer 50 is provided as a single component, on the other hand, the tolerance is only ±0.005 mm. Thus, variation of the thickness of the component laminate can be reduced.

Since the dummy spacer 50 is sufficiently thicker than the dummy arms and the like, the center of gravity of the HSA can be adjusted with ease, so that the design flexibility of the dummy spacer can be enhanced. The balancing portion 54 of the dummy spacer 50 is opposed to the arm 40 across a gap without directly contacting the arm, so that it never hinders displacement of the arm.

Thus, there can be obtained a head stack assembly capable of reducing the number of man-hours for assembly and the manufacturing cost, as well as fluctuations of the position of the center of gravity, and an HDD provided with same.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

In connection with the foregoing embodiment, for example, a disk device has been described that can be mounted with two magnetic disks at the most. However, the present invention is also applicable to a disk device and a head stack assembly that can be mounted with three or more magnetic disks at a time. If two HGAs are attached to a bearing portion that is configured to be mounted with, for example, six HGAs as a maximum, the spacer body of the dummy spacer is formed with a thickness equal to the sum of those of two spacer rings and four arms as remaining ones, out of the maximum six. The balancing portion of the dummy spacer is formed to have the shape, size, and weight that can counterbalance the weight of the four HGAs.

Further, the materials of the components of the HSA can be variously selected without being limited to the embodiment described herein.

What is claimed is:

1. A head stack assembly comprising:
a bearing portion configured to be mounted with a first number of arms and a plurality of spacers situated between the adjacent arms in a stacked state;
a second number of arms, fewer than the first number, attached to the bearing portion and extending in the same direction from the bearing portion;
a spacer attached to the bearing portion and stacked in layers between the adjacent arms;
a plurality of suspensions and a plurality of heads attached to the arms individually;
a support frame extending from the bearing portion oppositely from the arms and supporting a coil; and
a dummy spacer integrally comprising a spacer body attached to the bearing portion in order to overlap the arms and formed with a thickness equal to the sum of those of the second number of arms and the spacer arranged between the second number of arms, and a balancing portion extending along the extension of the arms from the spacer body.

2. The head stack assembly of claim 1, wherein the balancing portion of the dummy spacer is located within a region which overlaps the arms.

3. The head stack assembly of claim 2, wherein the balancing portion is facing the arm with a gap between the balancing portion and the arm.

4. The head stack assembly of claim 1, wherein the spacer is annular and fitted on the outer periphery of the bearing portion, and the spacer body of the dummy spacer is fitted on the outer periphery of the bearing portion and formed with a condition that the outside diameter of a portion of the dummy spacer contacting the arm is equal to the outside diameter of a portion of the spacer contacting the arm.

5. The head stack assembly of claim 1, wherein the bearing portion comprises a sleeve comprising a flange portion on one end of the bearing portion, the arms and the spacer are stacked one another on the outer periphery of the sleeve, and the dummy spacer is fitted on the outer periphery of the sleeve and stacked between the flange portion and the arm.

6. A disk drive apparatus comprising:
a disk recording medium;
a drive unit supporting the disk and is configured to rotate the disk;
a head configured to perform information processing for the recording medium; and
a head stack assembly comprising:
a bearing portion configured to be mounted with a first number of arms and a plurality of spacers situated between the adjacent arms in a stacked state;
a second number of arms, fewer than the first number, attached to the bearing portion and extending in the same direction from the bearing portion;
a spacer attached to the bearing portion and stacked in layers between the adjacent arms;
a plurality of suspensions and a plurality of heads attached to the arms individually;
a support frame extending from the bearing portion oppositely from the arms and supporting a coil; and
a dummy spacer integrally comprising a spacer body attached to the bearing portion in order to overlap the arms and formed with a thickness equal to the sum of those of the second number of arms and the spacer arranged between the second number of arms, and a balancing portion extending along the extension of the arms from the spacer body,
wherein the head stack assembly is configured to support the head for movement with respect to the recording medium and is configured to locate the head in an arbitrary position with respect to the recording medium.

7. The disk drive apparatus of claim 6, wherein the balancing portion of the dummy spacer is located within a region which overlaps the arms.

8. The disk drive apparatus of claim 7, wherein the balancing portion is facing the arm with a gap between the balancing portion and the arm.

9. The disk drive apparatus of claim 6, wherein the spacer is annular and fitted on the outer periphery of the bearing portion, and the spacer body of the dummy spacer is fitted on the outer periphery of the bearing portion and formed with a condition that the outside diameter of a portion of the dummy spacer contacting the arm is equal to the outside diameter of a portion of the spacer contacting the arm.

10. The disk drive apparatus of claim 6, wherein the bearing portion comprises a sleeve comprising a flange portion on one end of the bearing portion, the arms and the spacer are stacked one another on the outer periphery of the sleeve, and the dummy spacer is fitted on the outer periphery of the sleeve and stacked between the flange portion and the arm.
